(19) United States
(12) Patent Application Publication
(10) Pub. No.: US 2026/0370114 A1
(43) Pub. Date: Nov. 19, 2026

(54) METHODS, DEVICES, AND SYSTEMS FOR OUTPUT CURRENT SENSING IN A MULTILEVEL POWER CONVERTER

(71) Applicant: pSemi Corporation, San Diego, CA (US)

(72) Inventor: Alok Mittal, Reading (GB)

(21) Appl. No.: 19/737,992

(22) Filed: Jul. 10, 2026

Related U.S. Application Data
(63) Continuation of application No. PCT/US2025/011278, filed on Jan. 10, 2025.
(60) Provisional application No. 63/620,369, filed on Jan. 12, 2024.

(51) Int. Cl. H02M 1/00; H02H 7/12; H02M 1/088; H02M 7/02

(52) U.S. Cl. CPC H02M 1/0009; H02H 7/1213; H02M 1/0012; H02M 1/088; H02M 7/02

(57) ABSTRACT

A multi-level power converter for current sensing includes a plurality of transistors and a controller coupled to the multi-level power converter. The controller measures a first current of a first replica transistor during a first time interval and a second current of a second replica transistor during a second time interval. The controller determines a current of an inductor based on a sum of the first current and the second current, where the summing occurs at a node including the first current and the second current.

### CROSS-REFERENCE TO RELATED APPLICATIONS

This application is a continuation of International Patent Application No. PCT/US2025/011278 filed Jan. 10, 2025 and entitled “METHODS, DEVICES, AND SYSTEMS FOR OUTPUT CURRENT SENSING IN A MULTILEVEL POWER CONVERTER,” which claims the benefit of and priority to U.S. Provisional Patent Application No. 63/620,369, filed on Jan. 12, 2024, entitled “METHODS, DEVICES, AND SYSTEMS FOR OUTPUT CURRENT SENSING IN A MULTILEVEL POWER CONVERTER,” all of which are hereby incorporated by reference in their entirety.

### TECHNICAL FIELD

The present disclosure generally relates to power electronic devices. More particularly, the present disclosure relates to DC-DC power converters.

### BACKGROUND

Many electronic products, particularly mobile computing and/or communication products and components (e.g., notebook computers, ultra-book computers, tablet devices, LCD and LED displays), require multiple DC (direct current) voltage levels. For example, radio frequency transmitter power amplifiers may require relatively high voltages (e.g., 12V or more), and logic circuitry may require a low voltage level (e.g., 1-2V). Some other circuitries may require an intermediate voltage level (e.g., 5-10V). Power converters are often used to generate a lower or higher voltage from a common power source, such as a battery, in order to meet the power requirements of different components in the electronic products.

### SUMMARY

Embodiments of the present disclosure are directed to a multi-level power converter. In some embodiments, the multi-level power converter may include a first transistor, a second transistor, a third transistor, and a fourth transistor. In some embodiments, the first transistor may be coupled to a first replica transistor and the second transistor may be coupled to a second replica transistor. In some embodiments, a controller may be coupled to the multi-level power converter. The controller may be configured to measure a first current of the first replica transistor during a first time interval and measure a second current of the second replica transistor during a second time interval, wherein the first time interval and the second time interval are non-overlapping. The controller may be further configured to determine a current of an inductor based on a sum of the first current and the second current, wherein the summing occurs at a node comprising the first current and the second current.

In some embodiments, the current of the inductor is an average current. In other embodiments, the current of the inductor is a gate-source current. In yet other embodiments, the current of the inductor is a gate-drain current. In other embodiments, the current of the inductor is a drain-source current.

In some embodiments, the first replica transistor is a reduced size replica of the first transistor and the second replica transistor is a reduced size replica of the second transistor.

In some embodiments, the muti-level power converter further includes a plurality of transistors, including the third transistor and the fourth transistor, between the first transistor and the second transistor.

In other embodiments, the first transistor is connected to an input terminal and the second transistor is connected to a reference input. In such embodiments, the controller may implement protection features based on the determined current. In some embodiments, the protection features include disabling high voltage disconnect in response to a fault condition.

In some embodiments, the current of the inductor is equal to the sum multiplied by the replica ration. In other embodiments, the current of the inductor is equal to the sum of the first current and the second current. In additional embodiments, the inductor is coupled to an output terminal. In some embodiments, the determined current of the inductor may be used for protection of the multi-level power converter.

In some embodiments, the first transistor is closed and the second transistor is open in configuration and the configuration may correspond to the first time interval. In additional embodiments, the first transistor is coupled to a flying capacitor of the switched capacitor circuit.

In other embodiments, the first transistor is open and the second transistor is closed in a configuration and the configuration may correspond to the second time interval. In additional embodiments, the second transistor is coupled to a flying capacitor of the switched capacitor circuit.

In some embodiments, the controller is capable of providing telemetry. In other embodiments, the controller may trim errors associated with a current signal of the determined current using offset or gain trimming.

In some embodiments, the third transistor is coupled to a third replica transistor and the fourth transistor is coupled to a fourth replica transistor. A first ratio of the first transistor to the first replica transistor and a second ratio of the second replica transistor may be different from a third ratio of third transistor to the third replica transistor and a fourth ratio of the fourth transistor to the fourth replica transistor. In such embodiments, the first transistor may be connected to an input terminal, the second transistor may be connected to a reference input, the third transistor may be coupled to the input terminal and the fourth transistor may be coupled to the reference input. In further embodiments, the first ratio and the second ratio may be less than the third ratio and the fourth ratio.

In some embodiments, the voltage of the inductor may include three levels. In such embodiments, the three levels may comprise a voltage of substantially zero V, a voltage between zero V and an input voltage, and the input voltage.

Another aspect of the present disclosure is directed to a multi-level power converter which may include a first pair of transistors and a second pair of transistors. In some embodiments, a controller may be coupled to the multi-level power converter, wherein the controller is configured to measure a first current of a first replica transistor coupled to a first transistor of the first pair of transistors during a first time interval. The controller may also be configured to measure a second current of a second replica transistor coupled to a second transistor of the first pair of transistors during a second time interval. The first time interval and the second time interval may be non-overlapping. In some embodiments, the controller is configured to determine a current of an inductor based on a sum of the first current and the second current, wherein the summing occurs at a node comprising the first current and the second current.

In some embodiments, the second pair of transistors comprises a third transistor and a fourth transistor. The third transistor may be coupled to a third replica transistor and the fourth transistor may be coupled to a fourth replica transistor. In some embodiments, a first ratio of the first transistor to the first replica transistor and a second ratio of the second transistor to the second replica transistor are different from a third ratio of the third transistor to the third replica transistor and a fourth ratio of the fourth transistor to the fourth replica transistor. In such embodiments, the first transistor is connected to an input terminal, the second transistor is connected to a reference input, the third transistor is coupled to the input terminal and the fourth transistor is coupled to the reference input. In some embodiments, the first ratio and the second ratio are less than the third ratio and the fourth ratio.

In yet another aspect of the present disclosure, a multi-level power converter may include a first transistor connected to an input terminal, a second transistor connected to a reference input, an inductor coupled to an output terminal, a first replica transistor coupled to the first transistor, a second replica transistor coupled to the second transistor, and a controller coupled to the multi-level power converter. In some embodiments, the controller is configured to measure a first current of the first replica transistor during a first time interval and measure a second current of the second replica transistor during a second time interval, wherein the first time interval and the second time interval are non-overlapping. In some embodiments, the controller determines a current of the inductor based on a sum of the first current and the second current, wherein the summing occurs at a node comprising the first current and the second current.

In some embodiments, the multi-level power converter may provide current from a flying capacitor to the output terminal. In other embodiments, the inductor is coupled to an output terminal.

In yet another embodiment of the present disclosure, a multi-level power converter may include a switched-capacitor circuit including a first transistor indirectly coupled to an input terminal, a second transistor indirectly coupled to a reference input, and an inductor coupled to an output terminal. The multi-level converter may also include a first replica transistor coupled to the first transistor, a second replica transistor coupled to the second transistor, and a controller. The controller may be configured to measure a first current of the first replica transistor during a first time interval and measure a second current of the second replica transistor during a second time interval, wherein the first time interval and the second time interval are non-overlapping. In some embodiments, the controller determines a current of the inductor based on a sum of the first current and the second current, wherein the summing occurs at a node comprising the first current and the second current.

In some embodiments, a third transistor is coupled to a third replica transistor and a fourth transistor is coupled to a fourth replica transistor. A first ratio of the first transistor to the first replica transistor and a second ratio of the second transistor to the second replica transistor are different from a third ratio of third the third transistor to the third replica transistor and a fourth ratio of the fourth transistor to the fourth replica transistor. In such embodiments, the third transistor may be connected to the input terminal and the fourth transistor may be connected to the reference input. In some embodiments, the first ratio and the second ratio may be greater than the third ratio and the fourth ratio.

In yet another embodiment, a multi-level power converter may include a first transistor, a second transistor, a third transistor, a fourth transistor, a fifth transistor, and a sixth transistor. In some embodiments, the first transistor may be coupled to a first replica transistor and the second transistor may be coupled to a replica transistor. The multi-level power converter may include a controller coupled to the multi-level power converter, where the controller is configured to measure a first current of the first replica transistor during a first time interval and measure a second current of the second replica transistor during a second time interval, wherein the first time interval and the second time interval are non-overlapping. In some embodiments, the controller determines a current of the inductor based on a sum of the first current and the second current, wherein the summing occurs at a node comprising the first current and the second current.

In some embodiments, the multi-level power converter further comprises a plurality of transistors, including a third transistor and the fourth transistor, between the first transistor and the second transistor. In some embodiments, the multi-level power converter comprises a plurality of transistors, including the third transistor, the fourth transistor, the fifth transistor, and the sixth transistor between the first transistor and the second transistor.

In some embodiments, the fifth transistor is coupled to a fifth replica transistor and the sixth transistor is coupled to the sixth replica transistor. A fifth ratio of the fifth transistor to the fifth replica transistor and a sixth ratio of the sixth transistor to the sixth replica transistor may be different from the first ratio of the first transistor to the first replica transistor, the second ratio of the second transistor to the second replica transistor, the third ratio of the third transistor to the third replica transistor, and the fourth ratio of the fourth transistor to the fourth replica transistor.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

### BRIEF DESCRIPTION OF THE DRAWINGS

Embodiments and various aspects of the present disclosure are illustrated in the following detailed description and the accompanying figures. It is noted that, in accordance with standard practice in the industry, various features are not drawn to scale. In fact, the dimensions of the various features may be arbitrarily increased or reduced for clarity of discussion.

FIG. 1 illustrates a schematic of a multi-level power converter, in accordance with an inductor DC resistance (DCR) current sensing configuration.

FIG. 2 illustrates a schematic of a multi-level power converter, in accordance with a Rsense current sensing configuration.

FIG. 3 illustrates a schematic of a power converter, in accordance with a replica current sensing configuration.

FIG. 4 illustrates a schematic of a multi-level power converter.

FIG. 5A illustrates a diagram of voltage gate source (VGS) voltage and FET current waveforms for an example multi-level current sensing configuration, consistent with embodiments of the present disclosure.

FIG. 5B illustrates an example multi-level power converter current sensing configuration, consistent with embodiments of the present disclosure.

FIG. 6 illustrates an example multi-level power converter current sensing configuration, consistent with embodiments of the present disclosure.

FIG. 7 illustrates a table showing possible states for current flow associated with the multi-level power converter current sensing configuration of FIG. 6, consistent with embodiments of the present disclosure.

FIG. 8 illustrates an example multi-level power converter current sensing configuration, consistent with embodiments of the present disclosure.

FIG. 9A illustrates a table showing the possible states for current flow associated with the multi-level power converter current sensing configuration of FIG. 8, consistent with embodiments of the present disclosure.

FIG. 9B illustrates a table, which is a continuation of the table of FIG. 9A, consistent with embodiments of the present disclosure.

FIG. 10 is a schematic illustrating how a voltage equivalent to the inductor current may be found, consistent with embodiments of the present disclosure.

FIG. 11 illustrates example multi-level converter waveforms, consistent with embodiments of the present disclosure.

FIG. 12 illustrates example waveforms, consistent with embodiments of the present disclosure.

FIG. 13 illustrates an exemplary schematic of how high-side current may be generated, consistent with embodiments of the present disclosure.

FIG. 14 illustrates an exemplary schematic of how low-side current may be generated, consistent with embodiments of the present disclosure.

FIG. 15 illustrates an exemplary schematic of a telemetry application, consistent with embodiments of the present disclosure.

### DETAILED DESCRIPTION

The following disclosure provides many different exemplary embodiments, or examples, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Throughout the figures, components may be referenced using a combination of alphanumeric characters, some of which may include subscripts. Within this specification, the subscripts may be formatted as plain characters. For example, “V_{HIGH}” from the figures may be referred to as “VHIGH” within the specification. As another example, “Q₁” from the figures may be referred to as “Q1” within the specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this document, the term “coupled” may also be termed as “electrically coupled,” and the term “connected” may be termed as “electrically connected.” “Coupled” and “connected” may also be used to indicate that two or more elements cooperate or interact with each other.

Throughout this disclosure, embodiments are discussed in relation to particular electrical components, such as capacitors and inductors. Although an individual component may be discussed (e.g., a single capacitor, a single inductor), a combination of multiple components may be substituted for the single component. For example, while a single capacitor may be discussed or depicted, two or more capacitors (e.g., in series, parallel, or a combination of the two) may be substituted so long as the required qualities remain the same. In this example, an embodiment that calls for a single 20 mF capacitor may use two capacitors of 10 mF in parallel instead. Similar substitutions may be made for inductors.

Various embodiments of the present disclosure will be described with respect to embodiments in a specific context, such as a switched capacitor power converter. As used in this disclosure, the term “switched capacitor converter” may refer to a switched-capacitor network configured to convert an input voltage to an output voltage. The network may use switches to change between two or more circuit configurations to alter the voltage between the input and output terminals. Although not discussed in detail herein, disclosed embodiments may rely on level shifters and gate drivers to control the switches between open and closed states. Disclosed embodiments may operate using varying switching frequencies, such as 50 kHz to 500 MHz.

Disclosed embodiments may include circuits and techniques to power converters and more particularly to power converters having a high voltage conversion ratio, requiring small output current ripple, and demanding fast-dynamic response. Disclosed embodiments may include a converter that is particularly suitable to power microprocessors in data centers, telecom base stations, and consumer electronics.

Disclosed embodiments may include a power conversion circuit and architecture that can achieve high efficiency and high voltage conversion ratio. In some embodiments, the power conversion circuit and architecture may mix the operation of a switched capacitor charge distributor and a multiphase DC-DC voltage regulator. The circuits may include a magnetic structure and package, which may achieve high performance with a high voltage conversion ratio while offering low output current ripple and fast dynamic response. The converter can be used, for example, to supply electricity to low voltage high current microprocessors in data centers.

General-purpose and energy efficient computing may benefit from DC-DC converters with very low output voltage (<2V), high output current (>50A) and high voltage conversion ratio (>10:1). Power converters that can provide a low voltage output (<2 V) regulated at wide bandwidth, while drawing energy from a higher, wide-ranging input voltage (e.g., typically between 40V to 60V) may be useful for supporting high performance microprocessors and telecommunications processing loads. The size, cost, and performance advantages of integration may be desirable for designing modular and miniaturized DC-DC converters that can be easily scaled in size for a variety of applications with different voltage and current need.

An exemplary approach for the front-end stage of an intermediate bus architecture (IBA) may include a switched capacitor (SC) based DC-DC converter. This family of converters may be suited for high density designs. A SC circuit may include of a network of switches and capacitors, where the switches can be turned on and off periodically to cycle the network through different operational states. Switched capacitor DC-DC converters, however, may be limited in that they may provide relatively poor output voltage regulation in the presence of varying input voltage or load. As the conversion ratio differs from the optimal ratio, the efficiency of the switched capacitor converter may decrease.

A second stage for voltage regulation may be used in an IBA since both transformer-based DC-DC converters and SC based DC-DC converters are unregulated. The second stage may be implemented as a multi-phase buck converter regulating the output voltage from the intermediate bus. Decreasing the intermediate bus voltage can reduce the switching loss, enable higher switching frequency and improve the dynamic response of multi-phase buck converter. However, having a lower intermediate bus voltage may necessitate the front-end stage providing a higher voltage conversion ratio. Because SC-based DC-DC converters may have poor voltage regulation capabilities, multiple SC converters with fixed a step-down ratio may be cascaded in the front-end stage to fulfill a higher voltage conversion ratio. These approaches may not satisfactorily achieve desired levels of efficiency and power density for both front-end stage and second voltage regulator in the intermediate bus architecture. Disclosed embodiments may address these challenges to achieve high efficiency and fast dynamic response of the SC-based power converters while maintaining the high-bandwidth output regulation and high overall efficiency for point-of-load applications. It is to be appreciated the embodiments of the present disclosure are applicable to both buck and boost architecture of multi-level power converters.

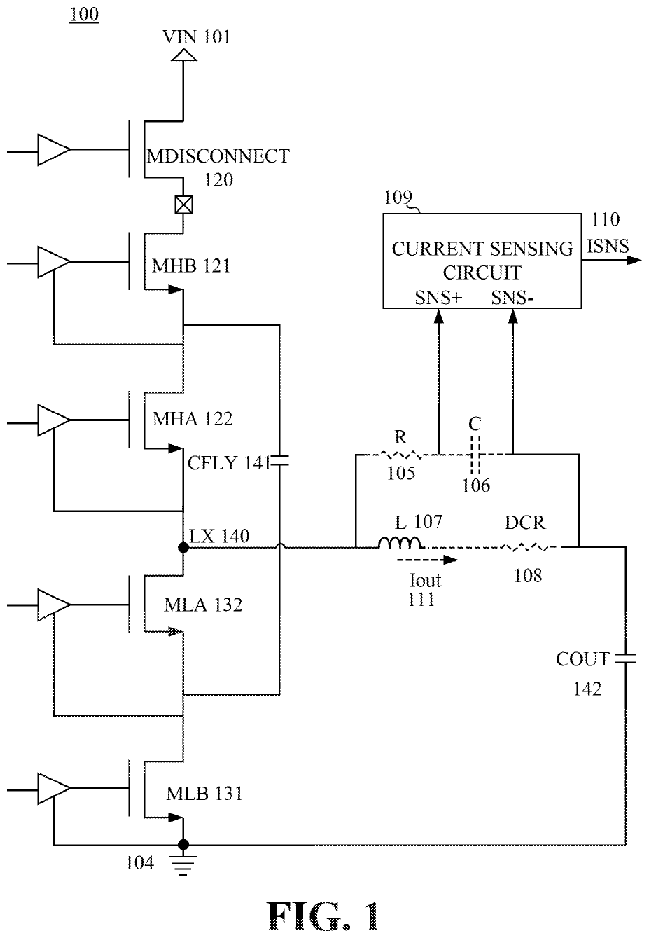

FIG. 1 illustrates a schematic of a three-level power converter, in accordance with an inductor DC resistance (DCR) current sensing configuration 100. DCR current sensing configuration 100 includes an input voltage 101, reference input 104, a disconnect transistor 120, a transistor MHB 121, a transistor MHA 122, a transistor MLA 132, a transistor MLB 131, a LX node 140, a flying capacitor CFLY 141, and an output capacitor COUT 142. DCR current sensing configuration 100 includes a resistor capacitor (RC) network, including resistor 105 and capacitor 106, is placed in parallel to an inductor 107 and DCR 108 combination. It should be understood that DCR 108 may represent a resistance in series with inductor 107 and may not be a physical component in DCR current sensing configuration 100. A current sensing circuit 109 measures the voltage across the capacitor 106. The current sensing circuit 109 outputs a sensed current ISNS 110. The voltage across the capacitor 106, measured by the current sensing circuit 109, is herein referred to as the sense voltage. The sense voltage is equivalent to the voltage across DCR 108 and is proportional to the current Iout 111 of inductor 107 (e.g., the sense voltage may be equal to the product of current Iout 111 and DCR 108).

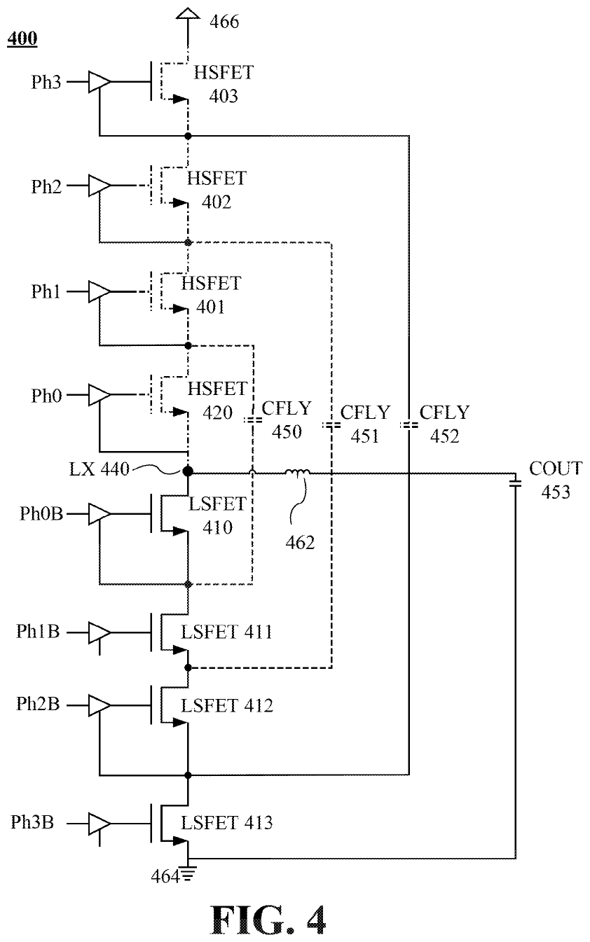

It is to be appreciated, for a three-level converter, the voltages across flying capacitor CFLY 141 are substantially equal to VIN/2 (the input voltage 101 divided by 2) in steady state. Further, in some embodiments, transistor MHB 121 and transistor MLB 131 have complementary clocks. Transistor MHA 122 and transistor MLA 132 also have complementary clocks (further shown and described in FIG. 4 below). Further, the direction of current Iout 111 as shown in FIG. 1 limits the direction of current to step down mode. In other embodiments, the direction of current Iout 111 may limit the direction of current to step up mode. Based on intended application, MDISCONNECT FET 120 may or may not be included as part of the current sensing configuration 100. As such, some representations of the present disclosure may be drawn without the MDISCONNECT FET 120.

The DCR current sensing configuration 100 has limitations. DCR current sensing depends on external components, requires additional board space, adds to bill of material (BOM) cost, and may have poor temperature tolerance without additional correction circuitry. In some instances of low output inductor 107 current Iout, a small sense voltage may be lost in noise.

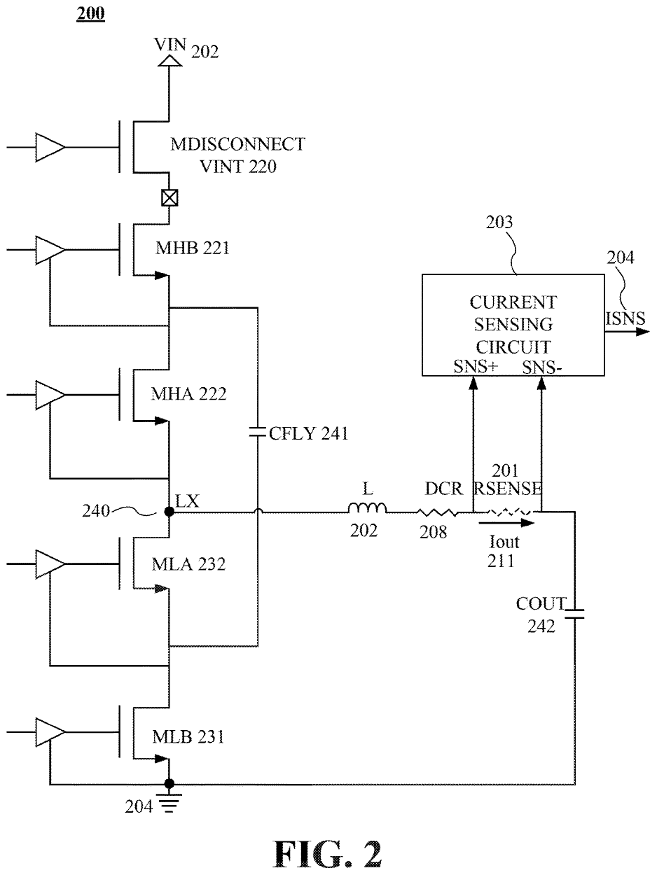

FIG. 2 illustrates a schematic of a multi-level power converter, in accordance with a resistor current sensing (Rsense) configuration 200. Rsense configuration 200 includes an input voltage 202, reference input 204, a disconnect transistor 220, a transistor MHB 221, a transistor MHA 222, a transistor MLA 232, a transistor MLB 231, a LX node 240, a flying capacitor CFLY 241, and an output capacitor COUT 242. Rsense configuration 200 includes a sense resistor RSENSE 201, which is inserted in the inductor 202 current (Iout) 211 path. A current sensing circuit 203 measures the voltage across RSENSE 201. The voltage across RSENSE 201 is the sense voltage. The sense voltage is the voltage equivalent to the inductor 202 current Iout 211 (e.g., the sense voltage is the product of the current Iout 211 and the resistance Rsense). The current sensing circuit 203 outputs a sensed current ISNS 204. It is to be appreciated no current summing circuit is necessary in embodiments of the present disclosure, because currents are directly injected into RSENSE 201. Notably, Rsense current sensing configuration 200 is one of the most accurate architectures for sensing average current.

However, the Rsense current sensing configuration 200 also has limitations. RSENSE 201 causes additional power dissipation and is therefore more inefficient than other current sensing configurations. The RSENSE component also adds to bill of material (BOM) cost.

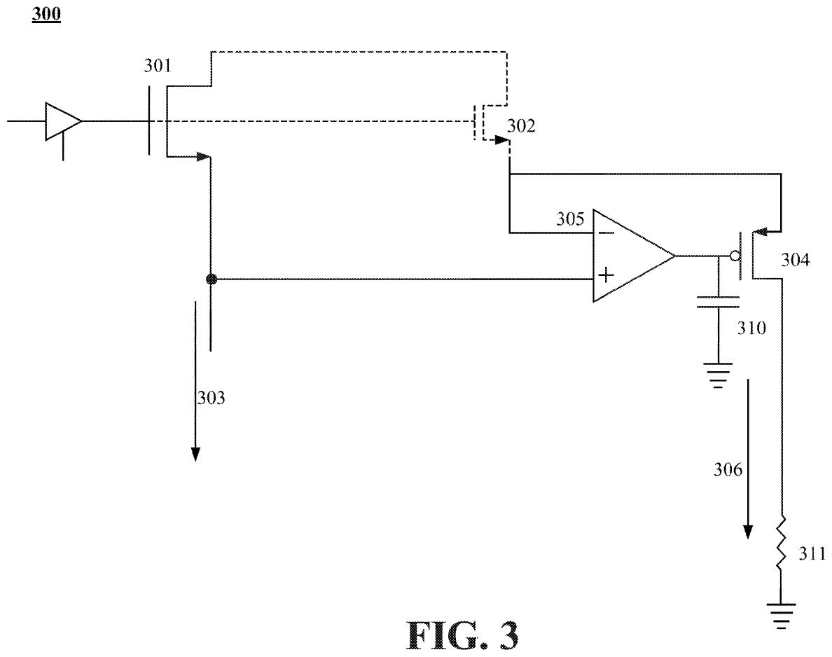

FIG. 3 illustrates a replica current sensing configuration 300 for use with a power converter as described previously. In this example, there exists a main FET 301 and a replica FET 302. The replica FET 302 has a higher drain-to-source ON resistance (RON) than the main FET 301. The output of the main FET 301 source terminal is the inductor current 303. The current through the replica FET 302 is a scaled current of the main FET 301. For example, if the current through the main FET 301 is I, the current through the replica FET 302 is I/(α), where α is the ratio of RON of the main FET 301 to RON of the replica FET 302. A current-to-voltage converter 304 outputs the sense voltage and sense current.

A loop including comparator 305, current-to-voltage converter 304, and capacitor 310 may charge or discharge capacitor 310 based on a difference between the source voltage of main FET 301 and the source voltage of replica FET 302. The loop aims to cause the source voltage of main FET 301 and the source voltage of replica FET 302 to be substantially the same such that the accuracy of measured inductor current 303 and measured sense current 306 through resistor 311 increases.

A replica current sensing configuration 300 may be preferred over DCR 100 and Rsense 200 current sensing configurations because replica current sensing 300 does not negatively impact efficiency, is accurate without requiring additional external components, and requires no additional BOM cost. However, replica current sensing 300 has limitations. It is performed separately for peak current and valley current tracking and must be repeated for each FET separately. This is a challenge for multi-level systems. Moreover, the main FET needs to be blanked to obtain peak current data, resulting in loss of information due to blanking glitches. If the main FET is not blanked, then the node LX may ring at switching transitions, thereby corrupting the current information. Small glitches during gate transitions may be filtered out and will have negligible effect on average current information. Additionally, replica ratio temperature/mismatch result in further inaccuracies in the sensing, which becomes significant at lower currents.

FIG. 4 is a schematic diagram illustrating an example five-level power converter 400. Traditional methods of measuring current information through each FET of a multi-level converter involve using the same number of replica FETs as the number of main FETs. This method way of measuring current information through each FET has downsides, including requiring additional area and causing temperature drift between the replica and main FET.

Multi-level power converter 400 may include an input terminal 466, a reference input 464, high side FETs 403, 402, 401, 420, low-side FETs 410, 411, 412, and 413, LX node 440, inductor 462, flying capacitors 450, 451, and 452, and output capacitor 453. Pairs of high side and low side switches are complementary to one another. For example, 420 and 410 are complementary to each other. 401 and 411 are complementary to each other, 402 and 412 are complementary to each other. 403 and 413 are complementary to each other. It is to be appreciated that without complementary switches, there runs a risk of shoot through current in the converter 400, where both high-side and low-side FETs turn on and create a short circuit across the power supply. It is to be appreciated that a deadtime exists between each switching configuration. Deadtime corresponds to all switches being turned off.

The high-side FETs and the low side FETs may operate in a complementary manner. Each pair of high side and low side FETs may be complementary. For example, when high side FET 403 is on, complementary low side FET 413 is off and when high side FET 403 is off, complementary low side FET 413 is on (e.g., similarly, high side FET 402 and low side FET 412, high side FET 401 and low side FET 411, and high side FET 420 and low side FET 410 are complementary pairs). Embodiments of the present disclosure are independent of which FET pair is chosen to measure current. In some embodiments, the outermost FET pair is preferred in choosing to measure current. Although only one pair of FETs is required, there may be associated benefits of using more than one pair of FETs for different applications (e.g., protection, control). In some embodiments, different pairs may be turned on for different applications. For example, an embodiment of the present disclosure may include four FETs, where the center (e.g., innermost) pair of FETs may be turned on for telemetry purposes and the outer pair turned on for control purposes. A controller (not shown) may cause the FETs to operate between on-off configurations.

As shown, complexity increases with an increase in the number of levels in a converter. The embodiments of the present disclosure are applicable to power converters of any number of levels (e.g., embodiments are independent of levels in buck converter). While conventional buck/boost converters have two states and two levels (Vin,0), multi-level converters have more than two states and levels. In fact, a multi-level converter with N levels has N−1 pairs of high side and low side FETs and N−1 zones. For example, a multi-level converter with 3 levels may have 2 pairs of high side and low side FETs (4 FETs), 2 zones (e.g., a first zone between 0 and Vin/2 and a second zone between Vin/2 and Vin), and 3 states in each zone (e.g., the first zone may have a first state where both high side FETs are off, a second state where a first high side FET is on and a second high side FET is off, and a third state where the first high side FET is off and the second high side FET is on; the second zone may have a first state where a first high side FET is on and a second high side FET is off, a second state where both high side FETs are on, and a third state where the first high side FET is off and the second high side FET is on). Moreover, each high side and low side pair may have a corresponding capacitor and two power switches. To further the complexity, each FET captures different output inductor current information, at each point in time.

Implementing a traditional replica current sensing configuration 300 for a multi-level converter 400 would require a replica FET for each main FET. As the number of states increases, the replica current sensing configuration 300 becomes impractical, inefficient, and expensive. To sense the multi-level power converter inductor current with a replica current sensing configuration 300, three challenges must be addressed. First, the number of current sensing replica elements required to capture the complete inductor output current should be minimized. Second, the replica requirement should be independent of levels and states to reduce design complexity and minimize area for a high level of multi-level architectures. Third, it should be determined how the current information from the replica FET will be used to extract average/peak current information with desired accuracy for a telemetry application. The present disclosure addresses these issues by accurately sensing inductor output current independent of the number of power converter levels.

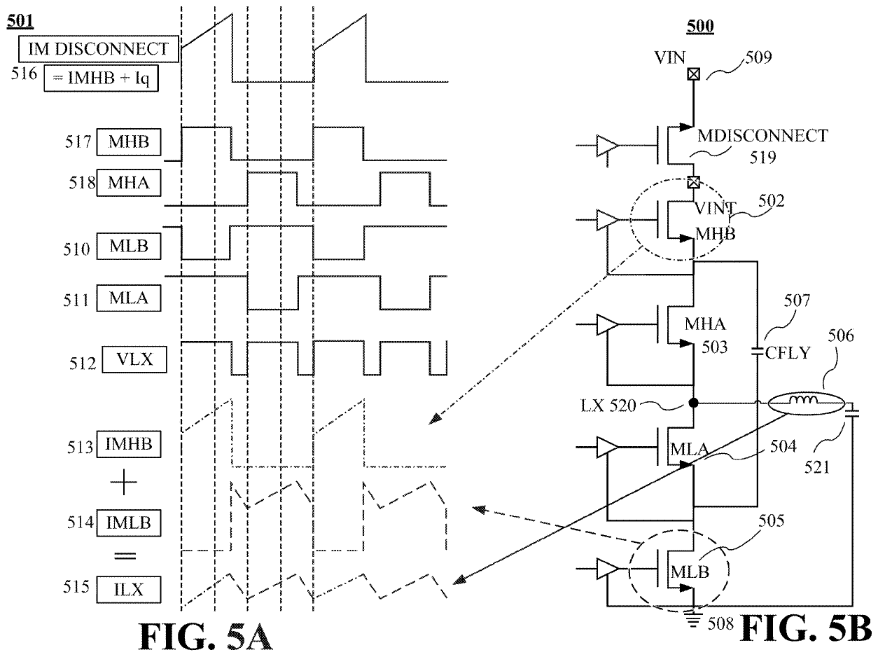

FIG. 5A illustrates a diagram 501 of VGS voltage and FET current waveforms for an example operation of a multi-level power converter current sensing configuration (e.g., of FIG. 5B), consistent with embodiments of the present disclosure. FIG. 5B illustrates an example multi-level power converter current sensing configuration 500, consistent with embodiments of the present disclosure.

In some embodiments, the multi-level power converter current sensing configuration 500 may include a first transistor 502 (e.g., a first high side transistor), a second transistor 503 (e.g., a second high side transistor), a third transistor 504 (e.g., a second low side transistor), and a fourth transistor 505 (e.g., a first low side transistor). A controller (not shown) may be coupled to the multi-level power converter. As described above, a disconnect transistor (e.g., MDISCONNECT 516) is not an integral part of the multi-level converter architecture. It may be removed in some embodiments. In some applications, MDISCONNECT 516 may be used as a switch to restrict an inrush current during an external short. In some embodiments, multi-level power converter current sensing configuration 500 may include a disconnect transistor 519 and an output capacitor 521.

In some embodiments, one or more of transistors 502-505 may each be coupled to a corresponding replica transistor (not shown). For example, a first replica transistor coupled to the first transistor 502 is a reduced size replica of the first transistor 502, a second replica transistor is a reduced size replica of the second transistor 503, a third replica transistor is a reduced size replica of the third transistor 504, a fourth replica transistor is a reduced size replica of the fourth transistor 505. The reduced size replicas reduce the current through the replica transistor current path. In some embodiments, the current of the inductor 506 is equal to the sum multiplied by the replica ratio. Reduced size replica transistors advantageously limit area and reduce power.

In an implementation, the controller may measure a first current of the first replica transistor (e.g., corresponding to transistor 502) during a first time interval and measure a second current of the second replica transistor (e.g., corresponding to transistor 505) during a second time interval. The first and second time intervals may be non-overlapping.

For example, a controller (not shown) may provide control signals to the multi-level power converter current sensing configuration 500. In some embodiments, the control signals may activate or de-activate one or more of the transistors 502-505 in a specific sequence, such that the multi-level power converter current sensing configuration 500 features multiple states of operation repeated at a specific frequency. For example, during a first state or state one, a first transistor (e.g., transistor 502) may be closed and a second transistor (e.g., transistor 505) may be open in a configuration at a first time interval. A closed transistor means current is flowing through the transistor. An open transistor means current is not flowing through the transistor.

In some embodiments, during a second state or state two, the first transistor 502 may be open and the second transistor 505 may be closed in a configuration at a second time interval that does not overlap the first time interval. In some embodiments, pairs of transistors (e.g., a high side transistor and a low side transistor) may operate in a complementary manner. For example, when transistor 502 is closed, transistor 505 is open and vice versa (e.g., when transistor 505 is open, transistor 502 is closed; when transistor 502 is open, transistor 505 is closed, etc.). In some embodiments, transistor 503 and 504 may also be paired such that when one of transistors 503 and 504 is closed, the other is open (e.g., when transistor 503 is closed, transistor 504 is open; when transistor 504 is closed, transistor 503 is open, etc.). A controller (not shown) may cause the transistors to operate between on-off (e.g., closed-open) configurations.

In some embodiments, when a transistor is used as a switch, there may be two modes of switching. In low side switching, input terminal 509 may be coupled to reference input 508. Current may travel through one or more of transistors 504 or 505 (e.g., “low-side” transistors) to reference input 508 in low-side switching. In high side switching, current may travel from input terminal 509, through one or more of transistors 502 or 503, to the LX node 520 (e.g., a load), to reference input 508. For example, in a three-level converter, transistors 502 and 503 may be closed at a first level (input voltage VIN). Transistors 502 and 504 or transistor 505 and 503 may be closed at a second level (input voltage divided by 2, VIN/2). Transistors 505 and 504 may be closed at a third level (voltage of reference input 508)

Multi-level power converter current sensing configuration 500 may include a switched capacitor circuit where the first transistor is coupled to a flying (fly) capacitor 507 of the switched capacitor current. The voltage of the fly capacitor 507 is charged to substantially a ratio of the input voltage. For a multi-level converter with three levels, the fly capacitor is charged to Vin/2. In some embodiments, the flying capacitor 507 may store and transfer energy between the multi-level power converter 500, to produce a desired voltage. In some embodiments, current may be transferred from flying capacitor 507 to an output terminal.

In some embodiments, a controller (not shown) coupled to the multi-level power converter current sensing configuration 500 may measure a first current of the first replica transistor (e.g., corresponding to transistor 502) during a first time interval and a second current of the second replica transistor (e.g., corresponding to transistor 505) during a second time interval. The first and second time-intervals may be non-overlapping (as described above) such that a current of an inductor 506 may be determined based on a sum of the first current and the second current. In some embodiments, the summing of the first current and the second current occurs at a node of the first current and the second current. For example, the first current and the second current input the node, resulting in a node output consisting of the summed first current and second current.

In some embodiments, the current of the multi-level power converter inductor 506 may be an average current. This may be implemented via filtering (e.g., low pass filter, etc.). In other ways, current may be averaged by extrapolating the current in the transition region based on the sampled current waveform and subsequently capturing the average current. The averaging of current via extrapolation provides an accurate average current, devoid of glitches. Additional filtering may also be added in implementation, based on specific requirements. In some embodiments, the current of the multi-level power converter inductor 506 may be a gate-source current, gate-drain current, and/or drain-source current. In some embodiments, the inductor 506 is coupled to an output terminal.

While four transistors 502-505 are shown, it should be understood that multi-level power converter current sensing configuration 500 may include any number of transistors (e.g., configuration 500 may have any number of voltage levels). In some embodiments, multi-level power converter current sensing configuration 500 may include a plurality of pairs of transistors, where when one transistor of a pair is closed, the other transistor of the pair is open and vice versa. For example, in some embodiments, five or more transistors may be included in multi-level power converter current sensing configuration 500.

In some embodiments, the first transistor 502 is connected to an input terminal 509 and the second transistor 505 is connected to a reference input 508. In some embodiments, the input terminal 509 may be a voltage input. In some embodiments, transistors 503 and 504 may be indirectly coupled to input terminal 509 and indirectly coupled to reference input 508. As described above, a controller (not shown) may measure the current through replica transistors corresponding to “outer” pair transistors 502 and 505. In some embodiments, a controller may measure the current through replica transistors corresponding to “inner” pair transistors (e.g., transistors 503 and 504). In some embodiments, the current through replica transistors of inner pair transistors may be measured to determine the current through inductor 506 and to implement protection features based on the determined current. The protection features may include disabling high voltage disconnect in response to a fault condition. In some embodiments, the inductor current may be used for protection of the multi-level current sensing configuration 500. In addition, the inductor current information may be used for an associated control loop of the multi-level converter to provide regulation. In some embodiments, control loops can be used for current mode control, average current control, or peak current control.

Embodiments of the present disclosure are advantageous in that only one pair of replica transistors corresponding to a pair of transistors may be measured to determine the current through inductor 506. Only one pair of replica transistors may be measured, independent of the number of levels or states in the power converter, thereby increasing efficiency, reducing costs, reducing design complexity, and minimizing area for a high level of multi-level architectures.

In some embodiments, the first ratio of the first transistor (e.g., transistor 502) to the first replica transistor and a second ratio of the second transistor (e.g., transistor 505) to the second replica transistor may be different from a third ratio of third transistor (e.g., transistor 503) to the third replica transistor and a fourth ratio of the fourth transistor (e.g., transistor 504) to the fourth replica transistor. In some embodiments, the first ratio and second ratio may be less than the third ratio and fourth ratio.

In some embodiments, the controller may trim errors associated with a current signal of the determined current using offset or gain trimming. Some potential sources of error include sense FET mismatch, temperature drift, amplifier offset, averaging glitches, and ripples. The multi-level power converter current sensing configuration 500 may be capable of providing telemetry.

By means of example and not limitation, the multi-level power converter current sensing configuration 500 of FIG. 5A may correspond to diagram 501 of the VGS voltage and FET current waveforms. The VGS voltage and FET current waveforms are an example of one possible state for the multi-level power converter current sensing configuration 500 of FIG. 5A.

FET current waveform 516 corresponds to disconnect transistor 519. VGS voltage waveform 517 corresponds to transistor 502, VGS voltage waveform 518 corresponds to transistor 503, VGS voltage waveform 510 corresponds to transistor 505, VGS voltage waveform 511 corresponds to transistor 504, and VGS voltage waveform 512 corresponds to LX node 520. As shown in waveforms 517, 518, 510, and 511, transistors 502-505 are two pairs of complementary transistors. That is when there is current flowing through transistor 502 (corresponding to waveform 517), there is no current flowing through complementary transistor 505 (corresponding to waveform 510), and vice versa. Similarly, when there is current flowing through transistor 503 (corresponding to waveform 518), there is no current flowing through complementary transistor 504 (corresponding to waveform 511).

Waveform 512 shows that only one pair of complementary transistors in multi-level power converter current sensing configuration 500 may be measured to determine the current through inductor 506 because in any number of states or transistors, current is flowing through one transistor of a complementary pair of transistors.

For example, FET current waveforms 513 (corresponding to transistor 502), 514 (corresponding to transistor 505), and 515 (corresponding to inductor 506) show that the current through inductor 506 is substantially equal to the sum of the current through transistor 502 (high side FET) and the current through transistor 505 (low side FET). In all states, the current is either flowing through either transistor 502 or transistor 505, regardless of the number transistors present in the system.

Embodiments of the present disclosure allow current sensing through only one pair of complementary transistors (e.g., the high side FET 502 and the low side FET 505), thereby allowing current information to be captured through the inductor 506 in all possible states and for any number of levels in a multi-level power converter. This concept is independent of the control scheme used for multi-level applications.

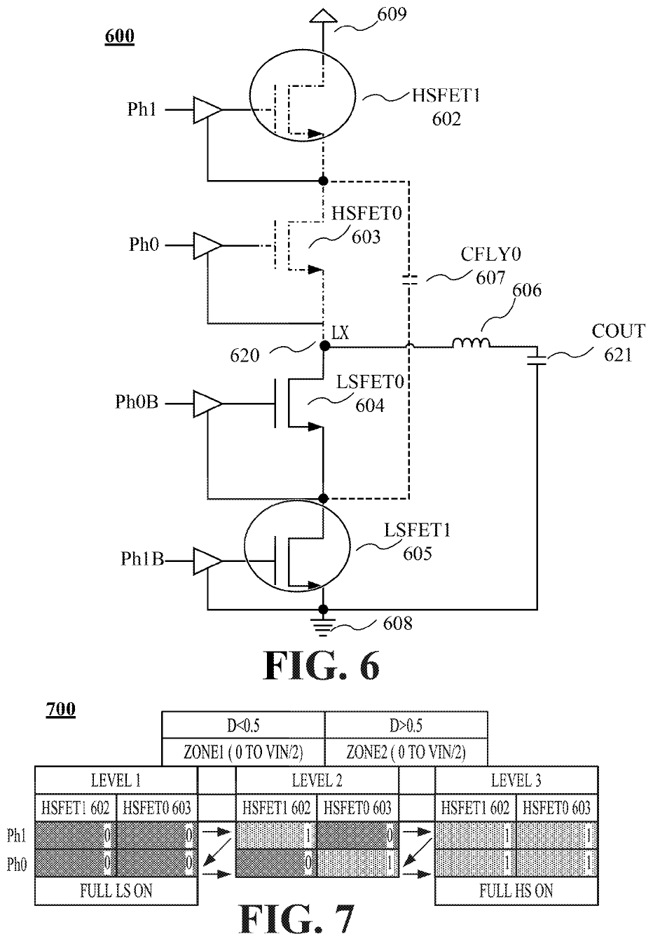

FIG. 6 illustrates an example multi-level power converter current sensing configuration 600 (e.g., multi-level power converter current sensing configuration 500 of FIG. 5B), consistent with embodiments of the present disclosure.

Similar to FIG. 5B, the multi-level power converter current sensing configuration 600 may include a first transistor 602 (e.g., a first high side transistor), a second transistor 603 (e.g., a second high side transistor), a third transistor 604 (e.g., a second low side transistor), and a fourth transistor 605 (e.g., a first low side transistor). A controller (not shown) may be coupled to the multi-level power converter. In some embodiments, multi-level power converter current sensing configuration 600 may include an output capacitor 621.

In some embodiments, one or more of transistors 602-605 may each be coupled to a corresponding replica transistor (not shown). For example, a first replica transistor coupled to the first transistor 602 is a reduced size replica of the first transistor 602, a second replica transistor is a reduced size replica of the second transistor 603, a third replica transistor is a reduced size replica of the third transistor 604, a fourth replica transistor is a reduced size replica of the fourth transistor 605. The reduced size replicas reduce the current through the replica transistor current path. In some embodiments, the current of the inductor 606 is equal to the sum multiplied by the replica ratio. Reduced size replica transistors advantageously limit area and reduce power.

In an implementation, the controller may measure a first current of the first replica transistor (e.g., corresponding to transistor 602) during a first time interval and measure a second current of the second replica transistor (e.g., corresponding to transistor 605) during a second time interval. The first and second time intervals may be non-overlapping.

For example, a controller (not shown) may provide control signals to the multi-level power converter current sensing configuration 600. In some embodiments, the control signals may activate or de-activate one or more of the transistors 602-605 in a specific sequence, such that the multi-level power converter current sensing configuration 600 features multiple states of operation repeated at a specific frequency. For example, during a first state or state one, a first transistor (e.g., transistor 602) may be closed and a second transistor (e.g., transistor 605) may be open in a configuration at a first time interval.

In some embodiments, during a second state or state two, the first transistor 602 may be open and the second transistor 605 may be closed in a configuration at a second time interval that does not overlap the first time interval. In some embodiments, pairs of transistors (e.g., a high side transistor and a low side transistor) may operate in a complementary manner. For example, when transistor 602 is closed, transistor 605 is open and vice versa (e.g., when transistor 605 is open, transistor 602 is closed; when transistor 602 is open, transistor 605 is closed, etc.). In some embodiments, transistor 603 and 604 may also be paired such that when one of transistors 603 and 604 is closed, the other is open (e.g., when transistor 603 is closed, transistor 604 is open; when transistor 604 is closed, transistor 603 is open, etc.). A controller (not shown) may cause the transistors to operate between on-off (e.g., closed-open) configurations.

Multi-level power converter current sensing configuration 600 may include a switched capacitor circuit where the first transistor is coupled to a flying capacitor 607 of the switched capacitor current. In some embodiments, the flying capacitor 607 may be used to balance voltage. In some embodiments, the flying capacitor 607 may store and transfer energy between the multi-level power converter 600, to produce a desired voltage.

In some embodiments, a controller (not shown) coupled to the multi-level power converter current sensing configuration 600 may measure a first current of the first replica transistor (e.g., corresponding to transistor 602) during a first time interval and a second current of the second replica transistor (e.g., corresponding to transistor 605) during a second time interval. The first and second time-intervals may be non-overlapping (as described above) such that a current of an inductor 606 (also the current through LX node 620) may be determined based on a sum of the first current and the second current.

In some embodiments, the current of the multi-level power converter inductor 606 may be an average current. This may be implemented via filtering (e.g., low pass filter, etc.). In some embodiments, the current of the multi-level power converter inductor 606 may be a gate-source current, gate-drain current, and/or drain-source current. In some embodiments, the inductor 606 is coupled to an output terminal.

In some embodiments, the first transistor 602 is connected to an input terminal 609 and the second transistor 605 is connected to a reference input 608. In some embodiments, the input terminal 609 may be a voltage input. In some embodiments, transistors 603 and 604 may be indirectly coupled to input terminal 609 and indirectly coupled to reference input 608. As described above, a controller (not shown) may measure the current through replica transistors corresponding to “outer” pair transistors 602 and 605. In some embodiments, a controller may measure the current through replica transistors corresponding to “inner” pair transistors (e.g., transistors 603 and 604). In some embodiments, the current through replica transistors of inner pair transistors may be measured to determine the current through inductor 606 and to implement protection features based on the determined current. The protection features may include disabling high voltage disconnect in response to a fault condition. In some embodiments, the inductor current may be used for protection of the multi-level current sensing configuration 600.

As discussed above, embodiments of the present disclosure are advantageous in that only one pair of replica transistors corresponding to a pair of transistors may be measured to determine the current through inductor 606.

In some embodiments, the first ratio of the first transistor (e.g., transistor 602) to the first replica transistor and a second ratio of the second transistor (e.g., transistor 605) to the second replica transistor may be different from a third ratio of third transistor (e.g., transistor 603) to the third replica transistor and a fourth ratio of the fourth transistor (e.g., transistor 604) to the fourth replica transistor. In some embodiments, the first ratio and second ratio may be less than the third ratio and fourth ratio.

In some embodiments, the controller may trim errors associated with a current signal of the determined current using offset or gain trimming. The multi-level power converter current sensing configuration 600 may be capable of providing telemetry.

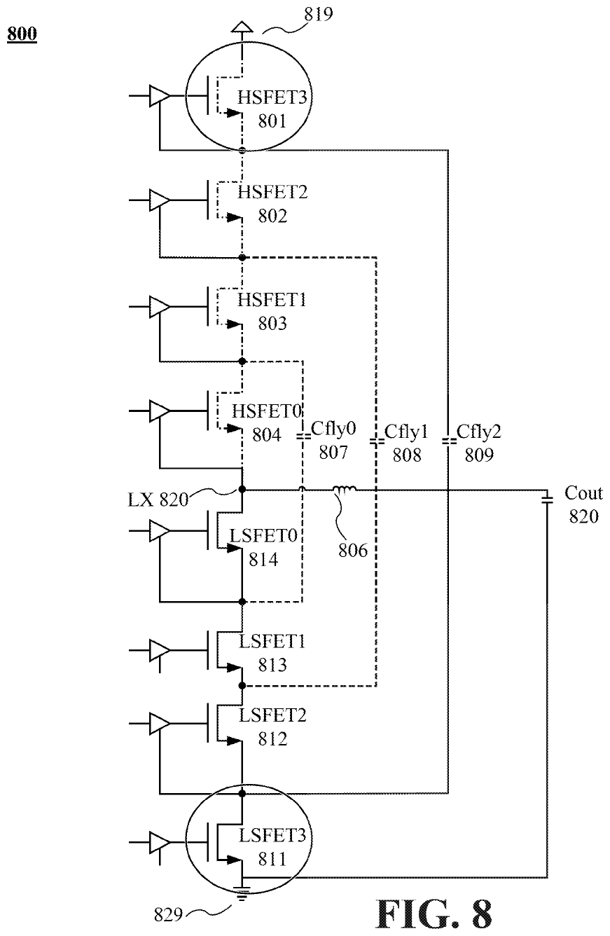

FIG. 7 illustrates a table 700 showing the possible states for current flow associated witha five-level power converter current sensing configuration 600 of FIG. 6, consistent with embodiments of the present disclosure. As shown in table 700, multi-level power converter current sensing configuration 600 is a 3-level power converter with 2 pairs of complementary transistors (e.g., pair of transistors 602 and 605 and pair of transistors 603 and 604). As shown in table 700, multi-level power converter current sensing configuration 600 has 2 zones with 3 states in each zone. In table 700, the row labeled Ph1 corresponds to the configuration of the Ph1 switch in FIG. 6, while the row labeled Ph0 corresponds to the configuration of the Ph0 switch in FIG. 6. With respect to the table 700 shown in FIG. 7, “0” corresponds to the FET being off and “1” corresponds to the FET being on. Referring to table 700, D<0.5 corresponds to a duty cycle less than 0.5 and D>0.5 corresponds to a duty cycle greater than 0.5.

High side and low side pairs of switches are complimentary of one another. For example, Ph0 and Ph0B are complimentary to each other. Ph1 and Ph1B are complimentary to each other, Ph02 and Ph02B are complimentary to each other. For example, in zone 1, the LX node 620 switches between a voltage level of 0 (level 1) and Vin/2 (level 2). Zone 1 may have a first state where both high side FETs (transistors 602 and 603) are off, a second state where a first high side FET (transistor 602) is on and a second high side FET (transistor 603) is off, and a third state where the first high side FET (transistor 602) is off and the second high side FET (transistor 603) is on. In zone 2, the LX node 620 switches between a voltage level of Vin/2 (level 2) and Vin (level 3). Zone 2 may have a first state where a first high side FET (transistor 602) is on and a second high side FET (transistor 603) is off, a second state where both high side FETs (transistors 602 and 603) are on, and a third state where the first high side FET (transistor 602) is off and the second high side FET (transistor 603) is on. The switching of the LX node 620 corresponds to cycles. As shown in table 700, a FET is off when its state is 0 and a FET is on when its state is 1.

In some embodiments, level 1 corresponds to the high side FETs (transistors 602 and 603) off and the low side FETs (transistors 604 and 605) on. In level 2, one high side FET (transistors 602 or 603) is on and one low side FET (transistors 604 or 605) is on. In level 2, there may be a current path through a high side FET and the flying capacitor for charging or a path through low side FET and the flying capacitor 607 for discharging. Level 3 corresponds to the high side FETs (transistors 602 and 603) on and the low side FETs (transistors 604 and 605) off. When the high side FETs are turned on, there is no current path through flying capacitor 607, as the input is coupled to the inductor 606. Explained another way, when both high side FETs are turned on, the bottom plate of CFLY 607 is floating (i.e., LFET0 604 and LFET1 605 are off). Thus, there is no current through CFLY 607 when both HFET1 602 and HFET0 603 are on.

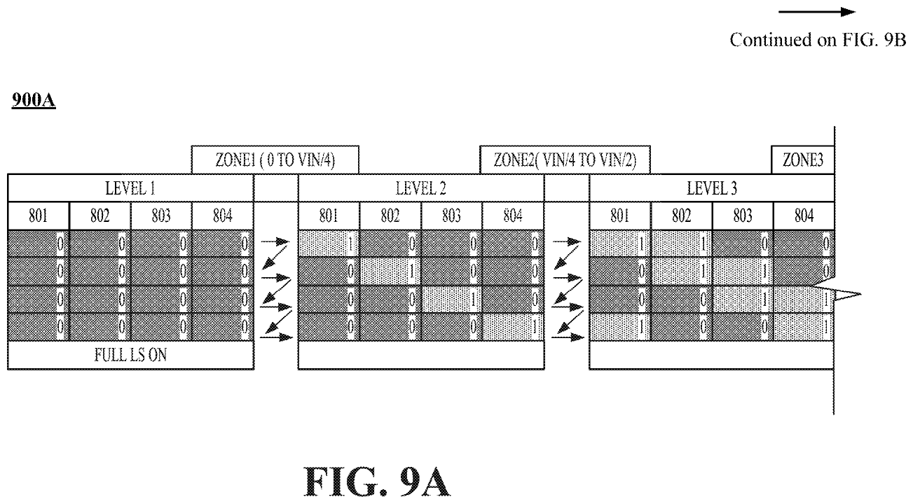

FIG. 8 illustrates an example multi-level power converter current sensing configuration 800 (e.g., multi-level power converter current sensing configuration 500 of FIG. 5B, multi-level power converter current sensing configuration 600 of FIG. 6), consistent with embodiments of the present disclosure.

Multi-level power converter current sensing configuration 800 operates in a manner similar to FIGS. 5B and 6, but differs in that it includes more pairs of inner transistors and has 5 levels. Multi-level power converter current sensing configuration 800 may include high side transistors 801-804 and complementary low side transistor 811-814, respectively. A controller (not shown) may be coupled to the multi-level power converter. In some embodiments, multi-level power converter current sensing configuration 800 may include an output capacitor 820.

In some embodiments, one or more of transistors 801-804 or 811-814 may be coupled to a corresponding replica transistor (not shown). The replica transistors may be reduced size replica transistors of their corresponding coupled transistor. The reduced size replicas reduce the current through the replica transistor current path. In some embodiments, the current of the inductor 806 is equal to the sum of currents through a pair of complementary transistors (e.g., transistor 801 and 811, transistors 802 and 812, transistors 803 and 813, transistors 805 and 814) multiplied by the replica ratio. Reduced size replica transistors advantageously limit area and reduce power.

In an implementation, the controller may measure a first current of the first replica transistor (e.g., corresponding to transistor 801) during a first time interval and measure a second current of the second replica transistor (e.g., corresponding to transistor 811) during a second time interval. The first and second time intervals may be non-overlapping.

For example, a controller (not shown) may provide control signals to the multi-level power converter current sensing configuration 800. In some embodiments, the control signals may activate or de-activate one or more of the transistors 801-804 or 811-814 in a specific sequence, such that the multi-level power converter current sensing configuration 800 features multiple states of operation repeated at a specific frequency. For example, during a first state or state one, a first transistor (e.g., transistor 801) may be closed and a second transistor (e.g., transistor 811) may be open in a configuration at a first time interval.

In some embodiments, during a second state or state two, the first transistor 801 may be open and the second transistor 811 may be closed in a configuration at a second time interval that does not overlap the first time interval. In some embodiments, pairs of transistors (e.g., a high side transistor and a low side transistor) may operate in a complementary manner. For example, when transistor 801 is closed, transistor 811 is open and vice versa (e.g., when transistor 811 is open, transistor 801 is closed; when transistor 801 is open, transistor 811 is closed, etc.). In some embodiments, transistors 802 and 812, 803 and 813, and 804 and 814 may also be paired such that when one of the transistors is closed, the other is open. A controller (not shown) may cause the transistors to operate between on-off (e.g., closed-open) configurations.

Five-level power converter current sensing configuration 800 may include a switched capacitor circuit where one or more transistors are coupled to one or more flying capacitors 807, 808, or 809 of the switched capacitor circuit. The flying capacitors 807, 808, or 809 may be used to balance voltage. With respect to the five-level power converter current sensing configuration 800, each flying capacitor 807, 808, and 809 is associated with a different voltage level. For example, in some embodiments, the voltage of Cfly0 807 is ¼VIN, the voltage of Cfly1 808 is ½VIN, and the voltage of Cfly2 809 is ¾VIN. Additional voltage levels of the five-level power converter include VIN and the voltage of the reference input 829. In some embodiments, the flying capacitors 807, 808, or 809 may store and transfer energy between the multi-level power converter 800, to produce a desired voltage.

In some embodiments, a controller (not shown) coupled to the multi-level power converter current sensing configuration 800 may measure a first current of the first replica transistor (e.g., corresponding to transistor 801) during a first time interval and a second current of the second replica transistor (e.g., corresponding to transistor 811) during a second time interval. The first and second time-intervals may be non-overlapping (as described above) such that a current of an inductor 806 (also the current through LX node 820) may be determined based on a sum of the first current and the second current.

In some embodiments, the current of the multi-level power converter inductor 806 may be an average current. This may be implemented via filtering (e.g., low pass filter, etc.). In some embodiments, the current of the multi-level power converter inductor 606 may be a gate-source current, gate-drain current, and/or drain-source current. In some embodiments, the inductor 806 is coupled to an output terminal.

In some embodiments, the first transistor 801 is connected to an input terminal 819 and the second transistor 811 is connected to a reference input 829. In some embodiments, the input terminal 819 may be a voltage input. In some embodiments, transistors 802-804 and 812-814 may be indirectly coupled to input terminal 819 and indirectly coupled to reference input 829. As described above, a controller (not shown) may measure the current through replica transistors corresponding to “outer” pair transistors 801 and 811. In some embodiments, a controller may measure the current through replica transistors corresponding to “inner” pair transistors (e.g., transistors 802 and 812, 803 and 813, 804 and 814). In some embodiments, the current through replica transistors of inner pair transistors may be measured to determine the current through inductor 806 and to implement protection features based on the determined current. The protection features may include disabling high voltage disconnect in response to a fault condition. In some embodiments, the inductor current may be used for protection of the multi-level current sensing configuration 800. In steady state, the voltage across Cfly0 807 may be substantially equal to VIN/4, the voltage across Cfly1 808 may be substantially equal to VIN/2, and the voltage across Cfly2 809 may be substantially equal to 3VIN/4.

As discussed above, embodiments of the present disclosure are advantageous in that only one pair of replica transistors corresponding to a pair of transistors may be measured to determine the current through inductor 806. In some embodiments, current is always flowing through one of transistors 801 or 811.

In some embodiments, the first ratio of the first transistor (e.g., transistor 801) to the first replica transistor and a second ratio of the second transistor (e.g., transistor 811) to the second replica transistor may be different from a third ratio of third transistor (e.g., transistor 802-804) to the third replica transistor and a fourth ratio of the fourth transistor (e.g., transistor 812-814) to the fourth replica transistor. In some embodiments, the first ratio and second ratio may be less than the third ratio and fourth ratio.

In some embodiments, the controller may trim errors associated with a current signal of the determined current using offset or gain trimming. The multi-level power converter current sensing configuration 800 may be capable of providing telemetry.

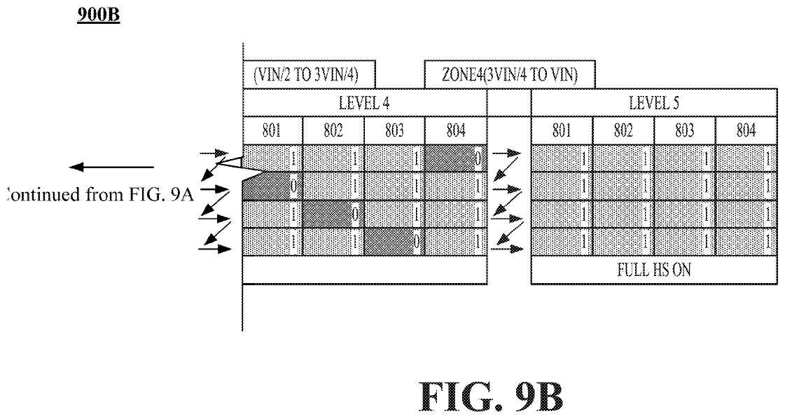

FIG. 9A illustrates a table 900A showing the possible states for current flow associated with multi-level power converter current sensing configuration 800 of FIG. 8, consistent with embodiments of the present disclosure. FIG. 9B illustrates a table 900B, which is a continuation of table 900A of FIG. 9A, consistent with embodiments of the present disclosure.

As shown in tables 900A and 900B, multi-level power converter current sensing configuration 800 is a 5-level power converter with 4 pairs of complementary transistors (e.g., pair of transistors 801 and 811, 802 and 812, 803 and 813, 804 and 814). As shown in tables 900A and 900B, multi-level power converter current sensing configuration 800 has 4 zones with 5 states in each zone. For example, in zone 1, the LX node 820 switches between a voltage level of 0 (level 1) and Vin/4 (level 2). Zone 1 may have a first state where all high side FETs (transistors 801-804) are off and second, third, fourth, and fifth states where one high side FET (transistors 801, 802, 803, or 804) is on. In zone 2, the LX node 820 switches between a voltage level of Vin/4 (level 2) and Vin/2 (level 3). In zone 3, the LX node 820 switches between a voltage level of Vin/2 (level 3) and 3Vin/4 (level 4). In zone 4, the LX node 820 switches between a voltage level of 3Vin/4 (level 4) and Vin (level 5). The switching of the LX node 820 corresponds to cycles. As shown in tables 900A and 900B, a FET is off when its state is 0 and a FET is on when its state is 1.

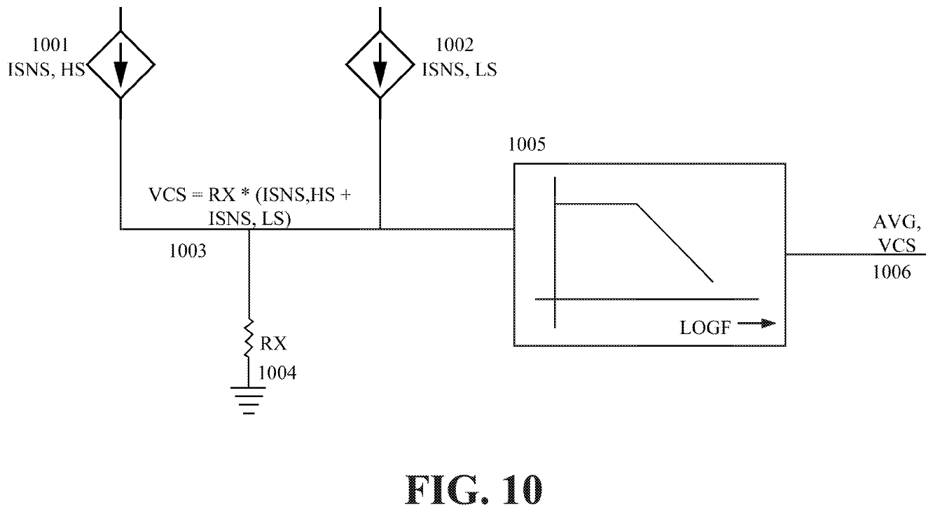

FIG. 10 is a schematic illustrating how a voltage equivalent to the inductor current (e.g., of inductor 506 of FIG. 5B, inductor 606 of FIG. 6, inductor 806 of FIG. 8) may be found, consistent with embodiments of the present disclosure. As shown, high-side current 1001 and low-side current 1002 may be summed. This current summation may be used to generate a VCS voltage 1003. In some embodiments, the VCS voltage 1003 is a scaled sum of the high-side current 1001 and low-side current 1002. A gain trim resistor (RX) 1004 may be shared between the high and low sides. The RX resistance value of RX 1004 may be the scale factor for calculating the voltage equivalent of the inductor current ISNS.

In some embodiments, a low-pass filter 1005 is applied after the high-side current 1001 and low-side current 1002 are summed and converted to average VCS 1003. The low-pass filter 1005 may have an input of VCS and output average VCS information 1006. The low-pass filter 1005 may filter out high frequency transition glitches, such that the averaged output current information scaled to VCS voltage 1003 by RX 1004 remains.

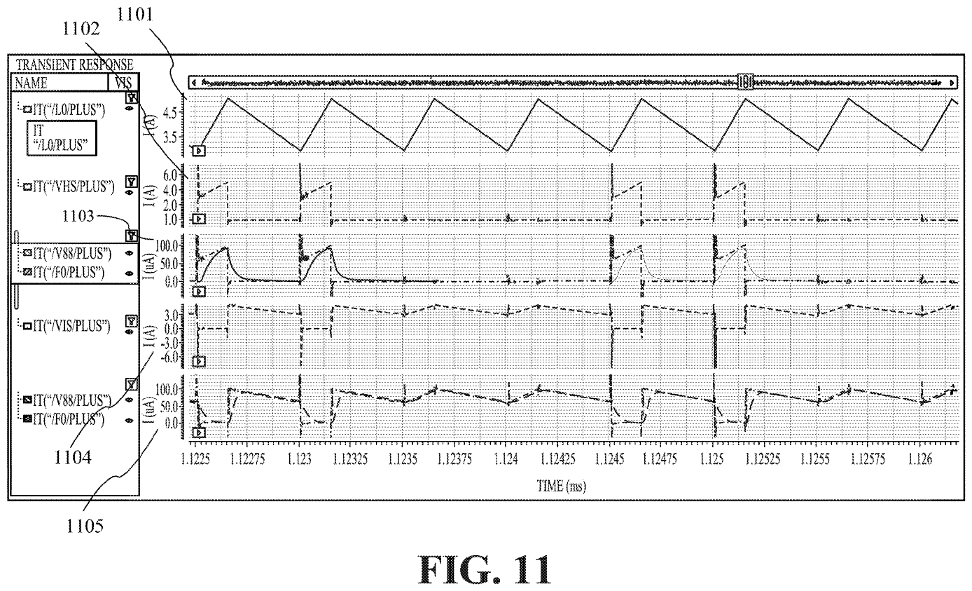

FIG. 11 illustrates example multi-level converter waveforms, consistent with embodiments of the present disclosure. As shown, waveform ILX 1101 is an example inductor current waveform (e.g., of inductor 506 of FIG. 5B, inductor 606 of FIG. 6, inductor 806 of FIG. 8). IHSFET(A) 1102 is an example high side FET current waveform. Note, the high side pulses of waveform ILX 1101 are not translated to the IHSFET(A) 1102 waveform. Waveform ILSFET(A) 1104 is an example low side FET current waveform. As shown, ILSFET(A) 1104 complements the IHSFET(A) waveform 1102. I_HSFET/50K 1103 is a scaled waveform of the high side FET current and I_LSFET/50K 1105 is a scaled waveform of the low side FET waveform. The scaled waveforms of FIG. 11 may be the scaled current through corresponding replica FETs, such as replica FETs associated with of ISNS, HS 1001 and ISNS, LS 1002 (see, e.g., FIG. 10). In some embodiments, a common mode filter may be applied to the currents shown in waveforms 1103 and 1105. As shown in FIG. 11, currents in waveforms 1103 and 1105 have a smooth transition due to loop bandwidth delays. Notably, if the scaled waveforms are added, a scaled version of ILX 1101 is produced.

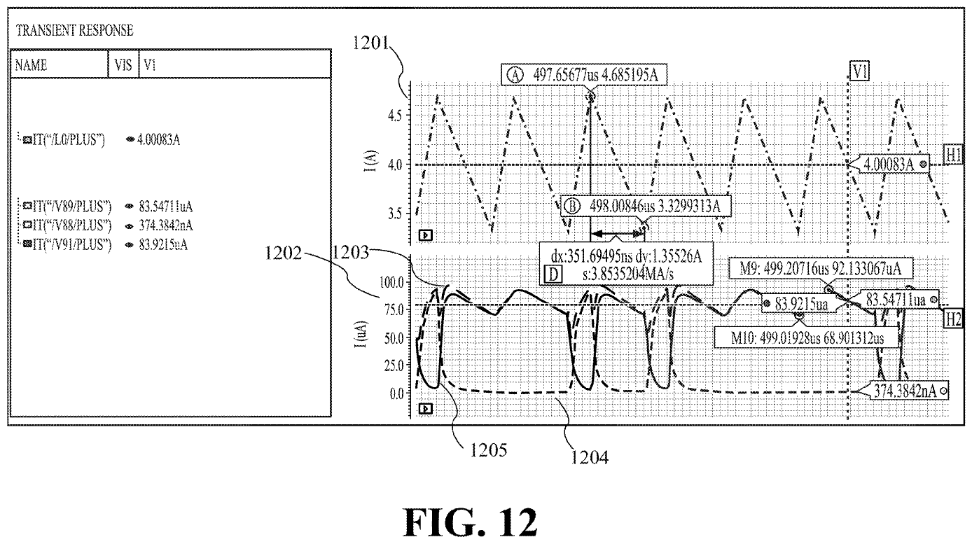

FIG. 12 illustrates example waveforms 1201 and 1202, consistent with embodiments of the present disclosure. Waveform 1201 is an example inductor current waveform (e.g., of inductor 506 of FIG. 5B, inductor 606 of FIG. 6, inductor 806 of FIG. 8). Waveform 1202 shows a summed current waveform 1203. The summed current waveform 1203 is the sum of a scaled low side current waveform 1204 (e.g., low side scaled current waveform 1105 of FIG. 11) and a scaled high side current waveform 1205 (e.g., high side scaled waveform 1103 of FIG. 11). The dips in the waveforms 1202 are due to glitches of the FET and represent missing information. Glitch energy averaging over the cycle causes higher peak values in the sensed waveform. Blanking and other processing techniques may be used to address the glitches.

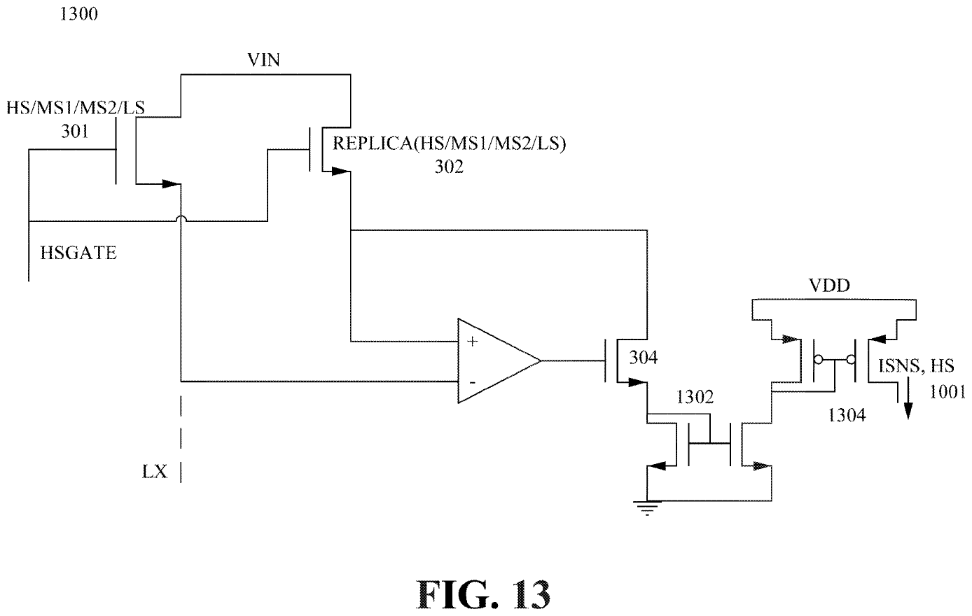

FIG. 13 is an exemplary schematic of how high-side current 1001 may be generated, consistent with embodiments of the present disclosure. In some embodiments, the high-side current 1001 corresponds with the high-side current 1001 of FIG. 10. Similar to FIG. 3, in FIG. 13, a main FET 301 is connected to a replica FET 302. The replica FET 302 voltage is approximately equal to the power FET 301 voltage. The current through the replica FET 302 is a scaled current of the current through the main FET 301. Current mirrors (e.g., current mirror 1302 and current mirror 1304) function to replicate the current output from the current-to-voltage converter 304. Notably, the high-side current 1001 is directed out of the current mirror. In some embodiments, the high-side current 1001 corresponds with high-side current 1001 in FIG. 10, where the high-side current 1001 is input into a circuit node with the low-side current 1002 for summing.

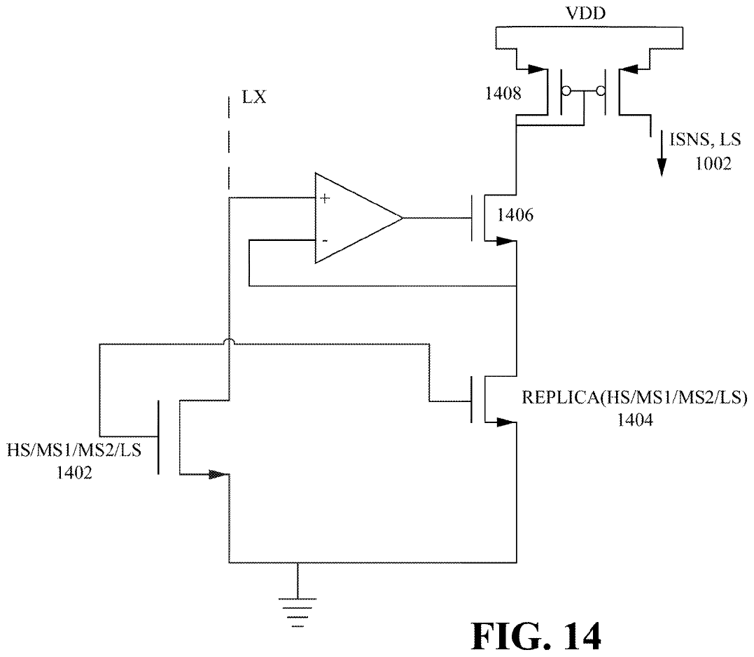

FIG. 14 is an exemplary schematic of how a low-side current 1002 may be generated, consistent with embodiments of the present disclosure. In some embodiments, the low-side current 1002 corresponds with the low-side current 1002 of FIG. 10. As shown in FIG. 14, a main FET 1402 is connected to a replica FET 1404. The replica FET 1404 voltage is approximately equal to the power FET 1402 voltage. The current through the replica FET 1404 is a scaled current of the current through the main FET 1402. Current mirror 1408 functions to replicate the current output from the current-to-voltage converter 1406. Notably, the low-side current 1002 is directed out of the current mirror 1408. In some embodiments, the low-side current 1002 corresponds with low-side current 1002 in FIG. 10, where the low-side current 1002 is input into a circuit node with the high-side current 1001 for summing.

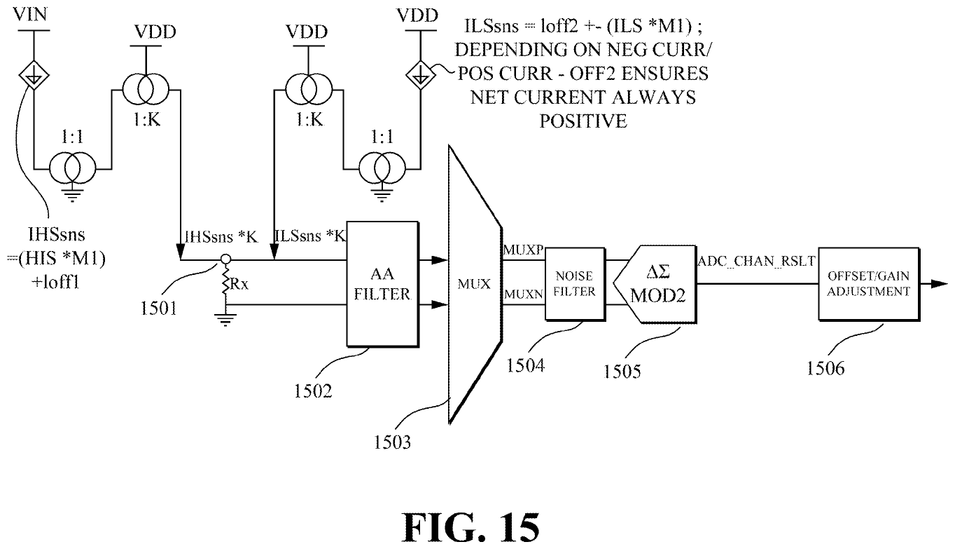

FIG. 15 is an exemplary diagram depicting a telemetry application, consistent with embodiments of the present disclosure. As shown, a high-side current may be converted into a voltage (i.e., IHS_sns*K). The low-side current may be converted into a voltage (i.e., ILS_sns*K) and meet at a node 1501 with the high-side current (or associated high-side voltage). The impedance at node 1501 may be Rx, to ensure the voltage (e.g., IHS_sns*K and ILS_sns*K) at the node corresponds to the sensed current. In some embodiments, the high-side and low-side voltage may be input into a filter, processed, and result in an offset or gain adjustment. An anti-aliasing filter (AA filter) may be used to limit the bandwidth of the signal at the ADC input 1503, to avoid aliasing and satisfy the Nyquist criteria. In some embodiments, a noise filter 1504 may be added to remove any differential noise. It is appreciated that noise filter 1504 is optional does not need to be included in the shown configuration. A sigma delta converter 1505 may convert analog input to corresponding digital code. The sigma delta converter 1505 is especially useful for high accuracy and low frequency input conversion. In some embodiments, a second order modulator may be used for improved noise shaping. The ADC modulated output, in some embodiments, may be filtered through a digital filter and post processed at 1506 for offset and gain trimming.

Disclosed embodiments may include switched-capacitor power converters. Switched-capacitors may also be referred to as cascade multipliers, switching capacitors, switched capacitors, switch capacitors, charge pumps, and voltage multipliers. The advantages and benefits of switched-capacitor power converters may enable them to be used in a wide array of applications. For example, applications of switched power converters include portable device, mobile computing, and/or communication products and components (e.g., notebook computers, ultra-book computers, tablet devices, and cell phones), displays (e.g., LCDs, LEDs), radio-based devices and systems (e.g., cellular systems, WiFi, Bluetooth, Zigbee, Z-Wave, and GPS-based devices), wired network devices and systems, data centers (e.g., for battery-backup systems and/or power conversion for processing systems and/or electronic/optical networking systems), internet-of-things (IOT) devices (e.g., smart switches and lights, safety sensors, and security cameras), household appliances and electronics (e.g., set-top boxes, battery-operated vacuum cleaners, appliances with built-in radio transceivers such as washers, dryers, and refrigerators), AC/DC power converters, use in electric vehicles of all types (e.g., for drive trains, control systems, and/or infotainment systems), and other devices and systems that utilize portable electricity generating sources and/or require power conversion.

Disclosed embodiments may include switched-capacitor power converters that utilize specific types of capacitors, particularly for the fly capacitors. For example, it may be useful for fly capacitors to have low equivalent series resistance (ESR), low DC bias degradation, high capacitance, and/or small volume. Low ESR may be of particular importance for switched-capacitor power converters that incorporate additional switches and fly capacitors to increase the number of voltage levels. Disclosed embodiments may include a particular capacitor based on a consideration of specifications for power level, efficiency, size, etc. Various types of capacitor technologies may be used, including ceramic (including multi-layer ceramic capacitors (MLCC)), electrolytic capacitors, film capacitors (including power film capacitors), and IC-based capacitors. Capacitor dielectrics may vary as needed for particular applications, and may include dielectrics that are paraelectric, such as silicon dioxide (SiO2), hafnium dioxide (HFO2), or aluminum oxide Al₂O₃. In addition, switched-capacitor power converter designs may beneficially utilize intrinsic parasitic capacitances (e.g., intrinsic to the power FETs) in conjunction with or in lieu of designed capacitors to reduce circuit size and/or increase circuit performance. Disclosed embodiments may also select capacitors for switched capacitor converters based on capacitor component variations, reduced effective capacitance with DC bias, and ceramic capacitor temperature coefficients (e.g., minimum and maximum temperature operating limits, and capacitance variation with temperature).

Similarly, in various embodiments of switched-capacitor power converters, it may be beneficial to use specific types of inductors. For example, disclosed embodiments may include inductors that have low DC equivalent resistance, high inductance, and small volume to increase performance.

Disclosed embodiments may include one or more controllers to control, for example, the startup and operation of disclosed embodiments. Controller(s) may be implemented as a microprocessor, a microcontroller, a digital signal processor (DSP), register-transfer level (RTL) circuitry, and/or combinatorial logic.

Disclosed embodiments may include one or more MOSFETs. In embodiments, a MOSFET may refer to any field effect transistor (FET) having an insulated gate whose voltage determines the conductivity of the transistor. In some embodiments, MOSFETS may encompass insulated gates having a metal or metal-like, insulator, and/or semiconductor structure. The metal or metal-like structures may include at least one electrically conductive material (such as aluminum, copper, or other metal, or highly doped polysilicon, graphene, or other electrical conductors). The insulator structures may include at least one insulating material (such as silicon oxide or other dielectric material). The semiconductor structures may include at least one semiconductor material.

Disclosed embodiments can meet a wide variety of specifications and may be implemented in any suitable integrated circuit (IC) technology (including but not limited to MOSFET structures), or in hybrid or discrete circuit forms. Integrated circuit embodiments may be fabricated using any suitable substrates and processes, including but not limited to standard bulk silicon, high-resistivity bulk CMOS, silicon-on-insulator (SOI), and silicon-on-sapphire (SOS). Unless otherwise noted above, embodiments of the invention may be implemented in other transistor technologies such as bipolar, BiCMOS, LDMOS, BCD, GaAs HBT, GaN HEMT, GaAs pHEMT, and MESFET technologies. Fabrication in CMOS using SOI or SOS processes may enable circuits with low power consumption, the ability to withstand high power signals during operation due to FET stacking, good linearity, and high frequency operation (e.g., radio frequencies up to and exceeding 300 GHz). Monolithic IC implementation may be useful since parasitic capacitances generally can be kept low (or at a minimum, kept uniform across all units, permitting them to be compensated) by careful design.

Voltage levels may be adjusted, and/or voltage and/or logic signal polarities reversed, depending on a particular specification and/or implementing technology (e.g., NMOS, PMOS, or CMOS, and enhancement mode or depletion mode transistor devices). Disclosed embodiments may adjust component voltage, current, and power handling capabilities as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functionality without significantly altering the functionality of the disclosed circuits.

Circuits and devices in accordance with the present disclosure may be used alone or in combination with other components, circuits, and devices. Embodiments may be fabricated as integrated circuits (ICs), which may be encased in IC packages and/or in modules for ease of handling, manufacture, and/or improved performance. For example, IC embodiments of the present disclosure may be used in modules in which one or more of such Ics are combined with other circuit components or blocks (e.g., filters, amplifiers, passive components, and possibly additional Ics) into one package. The Ics and/or modules may be then combined with other components, such as on a printed circuit board, to form part of an end product such as a cellular telephone, laptop computer, or electronic tablet, or to form a higher-level module which may be used in a wide variety of products, such as vehicles, test equipment, medical devices, etc. Through various configurations of modules and assemblies, such Ics may enable a mode of communication, such as wireless communication.

Embodiments may include implementations in hardware or software, or a combination of both (e.g., programmable logic arrays). In some embodiments, various general purpose computing machines may be used with programs written in accordance with the teachings herein. In other embodiments, a special purpose computer or special-purpose hardware (such as integrated circuits) may be used to perform particular functions. Embodiments may be implemented in one or more computer programs (i.e., a set of instructions or codes) executing on one or more programmed or programmable computer systems (which may be of various architectures, such as distributed, client/server, or grid) each including, for example, at least one processor, at least one data storage system (which may include volatile and non-volatile memory and/or storage elements), at least one input device or port, and/or at least one output device or port. Program instructions or code may be applied to input data to perform the functions described herein and generate output information. The output information may be applied to one or more output devices.

Disclosed embodiments may involve computer programs implemented in a computer language (e.g., machine, assembly, or high-level procedural, logical, object-oriented programming languages or a custom language/script) to communicate with a computer system and may be implemented in a distributed manner in which different parts of the computation specified by the software are performed by different processors. The computer language may be a compiled or interpreted language. Computer programs implementing certain embodiments may form one or more modules of a larger program or system of programs. Some or all of the elements of the computer program may be implemented as data structures stored in a computer readable medium or other organized data conforming to a data model stored in a data repository.

Disclosed embodiments may include computer program(s) that may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently, or permanently), the storage media or device being readable by a general or special purpose programmable computer for configuring and operating the computer when the storage media or device is read by the computer system to perform the procedures described above. Disclosed embodiments may also be implemented as a non-transitory computer-readable storage medium, configured with a computer program, where the storage medium so configured causes a computer system to operate in a specific or predefined manner to perform the functions described above.

In the specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is also intended that the sequence of steps shown in figures is only for illustrative purposes and is not intended to be limited to any particular sequence of steps. As such, those skilled in the art can appreciate that these steps can be performed in a different order while implementing the same method.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not to be considered essential features of those embodiments unless the embodiment is inoperative without those elements.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A multi-level power converter comprising:
a first transistor and a second transistor;
a first replica transistor coupled to the first transistor;
a second replica transistor coupled to the second transistor; and
a controller coupled to the multi-level power converter, wherein the controller is configured to:
measure a first current of the first replica transistor during a first time interval;
measure a second current of the second replica transistor during a second time interval, wherein the first time interval and the second time interval are non-overlapping; and
determine a current of an inductor based on a sum of the first current and the second current, wherein the summing occurs at a node comprising the first current and the second current.

2. The multi-level power converter of claim 1, wherein the first replica transistor is a reduced size replica of the first transistor and the second replica transistor is a reduced size replica of the second transistor.

3. The multi-level power converter of claim 1, wherein the first transistor is connected to an input terminal and the second transistor is connected to a reference input.

4. The multi-level power converter of claim 1, further comprising a third transistor and a fourth transistor between the first transistor and the second transistor.

5. The multi-level power converter of claim 4, wherein the third transistor is coupled to a third replica transistor and the fourth transistor is coupled to a fourth replica transistor, and wherein a first ratio of the first transistor to the first replica transistor and a second ratio of the second transistor to the second replica transistor are different from a third ratio of the third transistor to the third replica transistor and a fourth ratio of the fourth transistor to the fourth replica transistor.

6. The multi-level power converter of claim 5, wherein the first ratio and the second ratio are less than the third ratio and the fourth ratio.

7. The multi-level power converter of claim 1, wherein the current of the inductor is an average current.

8. The multi-level power converter of claim 1, wherein the current of the inductor is one of a gate-source current, a gate-drain current, or a drain-source current.

9. The multi-level power converter of claim 1, further comprising a switched capacitor circuit including at least one flying capacitor, wherein at least one of the first transistor or the second transistor is coupled to the at least one flying capacitor.

10. The multi-level power converter of claim 1, wherein the controller is configured to at least one of: implement protection features based on the determined current, provide telemetry, or trim errors associated with a current signal of the determined current using offset or gain trimming.

11. The multi-level power converter of claim 10, wherein the protection features comprise disabling high voltage disconnect in response to a fault condition.

12. The multi-level power converter of claim 1, wherein a voltage of the inductor comprises at least three levels including a voltage of substantially zero V, at least one voltage between zero V and an input voltage, and the input voltage.

13. The multi-level power converter of claim 1, wherein the multi-level power converter is one of a buck converter or a boost converter.

14. The multi-level power converter of claim 1, further comprising a switched-capacitor circuit including at least one flying capacitor, and an inductor coupled to an output terminal, wherein at least one of the first transistor or the second transistor is coupled to the at least one flying capacitor.

15. The multi-level power converter of claim 14, wherein the first transistor is one of directly or indirectly coupled to an input terminal, the second transistor is one of directly or indirectly coupled to a reference input, the first replica transistor is a reduced size replica of the first transistor and the second replica transistor is a reduced size replica of the second transistor, and wherein the current of the inductor is equal to the sum multiplied by a replica ratio.

16. A method comprising:
measuring a first current of a first replica transistor coupled to a first transistor of a plurality of transistors during a first time interval;
measuring a second current of a second replica transistor coupled to a second transistor of the plurality of transistors during a second time interval, wherein the first time interval and the second time interval are non-overlapping; and
determining a current of an inductor based on a sum of the first current and the second current, wherein the summing occurs at a node comprising the first current and the second current.

17. The method of claim 16, wherein the first transistor and the second transistor form a pair such that when the first transistor is closed the second transistor is open, and when the first transistor is open the second transistor is closed.

18. The method of claim 16, further comprising filtering the sum of the first current and the second current to obtain an average current of the inductor.

19. The method of claim 16, wherein the plurality of transistors and the inductor are part of a multi-level power converter includes a switched capacitor circuit with at least one flying capacitor, and wherein the determining of the current of the inductor is independent of a number of levels of the multi-level power converter.

20. A multi-level power converter, comprising:
means for measuring a first current during a first time interval;
means for measuring a second current during a second time interval, wherein the first time interval and the second time interval are non-overlapping; and
means for determining a current of an inductor based on a sum of the first current and the second current, wherein the summing occurs at a node comprising the first current and the second current.
